(19) United States
(12) Patent Application Publication
(10) Pub. No.: US 2026/0192476 A1
(43) Pub. Date: Jul. 9, 2026

(54) AUTOMATED TISSUE SKIVING

(71) Applicant: Edwards Lifesciences Corporation, Irvine, CA (US)

(72) Inventors: Chacphet Limsakoune, Corona, CA (US); Marius Tomas Petrulis, Long Beach, CA (US); Oliver Abraham Perez Oramas, Rancho Santa Margarita, CA (US); Safat Mohammad Kazi, Corona, CA (US); Shawn Michael Boeker, Garden Grove, CA (US); Lorenzo Petty, JR., Chino, CA (US)

(21) Appl. No.: 19/562,474

(22) Filed: Mar. 10, 2026

Related U.S. Application Data
(63) Continuation of application No. PCT/US2024/046133, filed on Sep. 11, 2024.
(60) Provisional application No. 63/582,303, filed on Sep. 13, 2023.

(51) Int. Cl. B26D 5/02; B26D 1/10; B26D 5/08; B26D 7/02

(52) U.S. Cl. CPC B26D 5/02; B26D 1/10; B26D 5/08; B26D 7/02

(57) ABSTRACT

Described herein are automated skiving devices that automate the process of skiving tissue. The automated skiving devices are configured to secure and move a cutting apparatus in a manner that allows the cutting apparatus to float over the surface of tissue to be skived. The automated skiving devices are configured to apply a targeted downward force on the cutting apparatus to achieve targeted performance in skiving the tissue. The disclosed devices include a clamping system that securely holds the cutting apparatus while allowing the cutting apparatus to roll and pitch while the cutting apparatus skives the tissue. The clamping system includes a weighted arm that applies a targeted downward force on the cutting apparatus. The weighted arm can be configured to have a tailored amount of weight to achieve a tailored downward force on the cutting apparatus.

This application is a continuation of PCT Patent Application No. PCT/US2024/046133, filed on September 11, 2024, which application claims priority to U.S. Provisional Patent Application Serial No. 63/582,303, filed on September 13, 2023 and entitled “AUTOMATED TISSUE SKIVING,” each of these applications being hereby incorporated by reference herein in its entirety.

### BACKGROUND

### FIELD

The present disclosure generally relates to devices and methods for tissue skiving.

### DESCRIPTION OF RELATED ART

Tissue skiving, also known as thinning or tapering, is a process used in a variety of industries including the medical field. In the medical field, tissue skiving involves reducing the thickness of a biological tissue to achieve a desired thickness profile. In the medical device industry, tissue skiving is utilized for creating tapered edges on certain biomaterials and soft tissues used in implants, grafts, or surgical procedures. Skiving helps to reduce the overall thickness of the material while maintaining its structural integrity, which can be advantageous for better fitting, improved flexibility, or enhanced performance in specific medical applications. The tissue skiving process generally involves securing the material and gradually reducing its thickness using a cutting tool or machine. The operator or machine controls the depth and angle of the cut to achieve the desired thinning or tapering effect.

### SUMMARY

According to a number of implementations, the present disclosure relates to an automated skiving machine. The automated skiving machine includes a cutting assembly configured to secure a cutting apparatus, the cutting assembly configured to enable the cutting apparatus to pitch and roll as the cutting apparatus skives a tissue, the cutting assembly configured to apply a tailored downward force on the cutting apparatus. The automated skiving machine also includes a vertical actuator assembly coupled to the cutting assembly and configured to vertically move the cutting assembly. The automated skiving machine also includes a horizontal actuator assembly coupled to the vertical actuator assembly and configured to horizontally move the vertical actuator assembly.

In some implementations, the automated skiving machine further includes a tray drawer assembly configured to hold the tissue to be skived. In some implementations, the tray drawer assembly includes a tissue clamp and a tissue bed. In some implementations, the automated skiving machine further includes a tray platform assembly to support the tray drawer assembly.

In some implementations, the cutting assembly comprises a pillow block and a pivot pin positioned within the pillow block, the pivot pin configured to rotate within the pillow block to allow the cutting assembly to roll as the cutting apparatus skives the tissue. In some implementations, the cutting assembly comprises a clamping system that includes a skiver clamp and a weight cup weldment, the clamping system including a first pin coupled to the weight cup weldment that is secured within a circular opening of the skiver clamp to establish an axis of rotation and a second pin coupled to the weight cup weldment that is secured within a slot of the skiver clamp to allow the cutting assembly to pitch as the cutting apparatus skives the tissue. In some implementations, the cutting assembly further includes a weight cup coupled to a clamping system of the cutting assembly, the weight cup configured to hold one or more weights to achieve the tailored downward force on the cutting apparatus.

In some implementations, the vertical actuator assembly includes a cantilever adapter coupled to a cantilever tray of the cutting assembly, the vertical actuator assembly further including a vertical actuator that vertically moves the cantilever adapter to thereby vertically move the cutting assembly. In some implementations, the vertical actuator assembly further includes a vertical actuator shelf that defines a lower bound for vertical movement of the cutting assembly, the cantilever tray of the cutting assembly configured to contact the vertical actuator shelf at the lower bound of vertical movement. In some implementations, the horizontal actuator assembly includes a horizontal carriage that couples to a vertical adapter of the vertical actuator assembly, the horizontal actuator assembly further including a horizontal actuator that horizontally moves the horizontal carriage to thereby horizontally move the vertical actuator assembly and the cutting assembly.

According to a number of implementations, the present disclosure relates to a method for automated tissue skiving. The method includes securing a cutting apparatus in a cutting assembly that is configured to enable the cutting apparatus to pitch and roll as the cutting apparatus skives a tissue. The method also includes applying a tailored downward force on the cutting apparatus. The method also includes vertically moving the cutting assembly to engage with tissue using a vertical actuator assembly coupled to the cutting assembly. The method also includes horizontally moving the vertical actuator assembly that is coupled to the cutting assembly, wherein horizontally moving the vertical actuator assembly causes the cutting assembly to horizontally move over the tissue to skive the tissue, the cutting assembly allowing the cutting apparatus to pitch and roll as the cutting assembly skives the tissue.

In some implementations, the method further includes securing a tissue in a tray drawer assembly beneath the cutting assembly. In some implementations, the tray drawer assembly includes a tissue clamp and a tissue bed.

In some implementations, the method further includes operating a user interface feature to initiate tissue skiving. In some implementations, the method further includes, responsive to detecting that a tray drawer assembly is not in position, turning off the cutting apparatus.

In some implementations, the cutting assembly comprises a clamping system that includes a skiver clamp and a weight cup weldment, the clamping system including a first pin coupled to the weight cup weldment that is secured within a circular opening of the skiver clamp to establish an axis of rotation and a second pin coupled to the weight cup weldment that is secured within a slot of the skiver clamp to allow the cutting assembly to pitch as the cutting apparatus skives the tissue. In some implementations, applying the tailored downward force on the cutting apparatus includes holding weights in a weight cup of the cutting assembly that is coupled to a clamping system of the cutting assembly.

In some implementations, vertically moving the cutting assembly includes operating a vertical actuator that vertically moves a cantilever adapter coupled to a cantilever tray of the cutting assembly. In some implementations, the method further includes limiting vertical movement of the vertical actuator assembly using a vertical actuator shelf that defines a lower bound for vertical movement of the cutting assembly, the cantilever tray of the cutting assembly configured to contact the vertical actuator shelf at the lower bound of vertical movement. In some implementations, horizontally moving the vertical actuator assembly includes operating a horizontal actuator to horizontally move a horizontal carriage that couples to a vertical adapter of the vertical actuator assembly to thereby horizontally move the cutting assembly.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

Various embodiments are depicted in the accompanying drawings for illustrative purposes and should in no way be interpreted as limiting the scope of any of the inventions disclosed herein. In addition, various features of different disclosed embodiments can be combined to form additional embodiments, which are part of this disclosure. Throughout the drawings, reference numbers may be reused to indicate correspondence between reference elements.

FIGS. 1A and 1B illustrate an example automated skiving machine.

FIGS. 2A, 2B, and 2C illustrate additional views of the automated skiving machine of FIGS. 1A and 1B with the safety guard assembly removed.

FIGS. 3A and 3B illustrate the vertical actuator assembly, the cutting assembly, the horizontal actuator assembly, and the tray drawer assembly of the automated skiving machine of FIGS. 1A and 1B.

FIGS. 4A, 4B, and 4C illustrate the vertical actuator assembly.

FIG. 5 illustrates a portion of the cutting assembly without the motor-driven dermatome.

FIGS. 6A, 6B, 6C, 6D, and 6E illustrate various views of the cutting assembly.

FIGS. 7A and 7B illustrate an assembled view and an exploded view of the cutting assembly with additional components for the motor-driven dermatome.

FIG. 8 illustrates the pillow block.

FIG. 9 illustrates the pivot pin.

FIG. 10 illustrates the clamp base.

FIG. 11 illustrates the skiver clamp.

FIGS. 12A and 12B illustrate the weight cup weldment.

FIG. 13 illustrates the base assembly.

FIGS. 14 and 15 illustrate various views of the controls assembly.

### DETAILED DESCRIPTION OF SOME EMBODIMENTS

The headings provided herein, if any, are for convenience only and do not necessarily affect the scope or meaning of the claimed invention.

### Overview

In the medical field, tissue skiving is a process used to thin or taper biological tissues for various applications, such as in the production of implants, grafts, or surgical procedures. Skiving tissue in a medical context is typically performed using surgical instruments specifically designed for this purpose. The process may involve selecting appropriate tissue based on the specific medical application. This could include biological tissues such as skin, tendons, or blood vessels obtained from a human or animal source, or synthetic biomaterials used for tissue engineering. After tissue selection, the tissue is often stabilized or secured to ensure it remains taut during the skiving process. Various skiving techniques may be used, depending on the desired outcome and the type of tissue being skived. For example, manual skiving involves using a surgical knife or scalpel to carefully thin or taper the tissue whereas mechanical skiving devices can be used to automate the process. Mechanical skiving devices may utilize rotating blades, oscillating knives, or other cutting mechanisms to thin the tissue consistently and rapidly. Mechanical skiving devices are especially useful for larger-scale production or when a high level of precision is required.

However, manually skiving tissue, even using a mechanical skiving device, may produce undesirable variations in tissue thickness because the operator has to maintain constant pressure, constant speed, and constant pitch and yaw during the skiving process to maintain desirable tissue thickness. For applications that benefit from thinner tissue, it may be even more important to consistently achieve the targeted thickness with high quality. For example, larger valves benefit from thinner tissues due to the desire to continue to implant such valves through a catheter. Larger valves are more difficult to collapse down to a size suitable for delivery in a catheter unless the tissue is suitably thin. Thus, if an operator is unable to achieve the targeted thickness with sufficiently high quality, the skived tissue may be rejected for use in a larger valve, resulting in wasted labor for the operator and wasted materials in the skived tissue.

By way of example, target valves for implants may include tricuspid and mitral valves which have a relatively large diameter annulus. As a result, although the valves have a relatively large diameter in an implanted state, the valves need to have a sufficiently small diameter in a collapsed state to fit in the catheter for delivery. Furthermore, the valves need to be collapsed to that diameter and they need to collapse in a desirable manner to avoid damaging or ruining the valve. Consequently, it is desirable to have increasingly thinner tissue to enable smaller collapsing for relatively large implants to enable delivery via catheter.

With this drive toward thinner tissue, the problems with manual skiving, even with mechanical skiving devices, become more pronounced. For example, an operator manually skiving tissue usually has a low yield because it is challenging to achieve sufficiently high quality for thinly skived tissue. Furthermore, there is a significant ergonomic impact on the operator performing the skiving process.

Accordingly, described herein are automated skiving devices that automate the process of skiving tissue. The devices include a floating cutting apparatus (e.g., a motor-driven dermatome such as an electric dermatome or a pneumatic dermatome) that moves with imperfections of the tissue along the tissue. The disclosed devices manufacture a superior coupon (e.g., an artificial leaflet for a valve) with higher yield. The disclosed devices manufacture superior coupons that are thinner and more consistent than manual skiving processes typically achieve. Thus, the disclosed devices provide coupons that can improve valves and that can enable smaller collapsing of the manufactured valves.

The automated skiving devices are configured to secure a cutting apparatus (e.g., a motor-driven dermatome such as an electric dermatome or a pneumatic dermatome) in a manner that allows the cutting apparatus to float over the surface of tissue to be skived as the cutting apparatus is moved across the surface of the tissue in an automated fashion. The automated skiving devices are configured to apply a targeted downward force on the cutting apparatus to achieve targeted performance in skiving the tissue, such as achieving a targeted thickness and/or a targeted uniformity in thickness. To achieve this performance, the disclosed devices include a clamping system that is configured to securely hold the cutting apparatus, the clamping system configured to allow the cutting apparatus to roll and pitch while the device moves the cutting apparatus forward over targeted tissue. In addition, the disclosed devices include a weighted arm that applies a targeted downward force on the cutting apparatus while the cutting apparatus is moved forward by the disclosed devices. The weighted arm can be configured to have a tailored amount of weight to achieve a targeted or tailored downward force and/or torque on the cutting apparatus. The tailored amount of weight advantageously enables consistent skiving results, especially compared to manual skiving.

The automated skiving methods disclosed herein include positioning targeted tissue (e.g., a pericardial sac) on a tray, loading the tray into an automated skiving device, and initiating operation of the automated skiving device. Initiating operation of the automated skiving device causes the cutting apparatus to power on (e.g., causing a razor blade of a motor-driven dermatome to oscillate) and for a cutting apparatus mount to lower to be able to contact the targeted tissue. The cutting apparatus is then automatically traversed across the targeted tissue that is secured on the tray to cause the cutting apparatus to skive the tissue. The operator can then remove the finished skived tissue at which time the position of the cutting apparatus mount can reset its position to begin the automated skiving method again. This process can be repeated multiple times to generate multiple finished skived tissue components (e.g., coupons or material for artificial leaflets).

As used herein, the cutting apparatus of the disclosed automated skiving machines can include any suitable device for skiving tissue. For example, the cutting apparatus can include a motor-driven dermatome. The motor-driven dermatome is a specialized surgical instrument designed to precisely remove thin layers of skin or tissue. A motor-driven dermatome is a handheld device with a blade or oscillating cutting mechanism. The depth of the cut can typically be adjusted to obtain grafts of varying thicknesses. During a skiving procedure, the motor-driven dermatome is applied to the tissue causing the blade to oscillate while the dermatome glides over the surface, the oscillating blade removing a thin layer of tissue. Examples of a motor-driven dermatome include a pneumatic dermatome (e.g., the motor is driven using pressurized air) or an electric dermatome (e.g., the motor is driven using electricity).

The disclosed cutting apparatuses can include an adjustable depth control mechanism. This allows an operator to control the depth of the cut and to determine the amount of material to be removed. In addition, a tailored amount of weight can be added to a weight arm to control the depth and consistency of the cut. The disclosed cutting apparatuses can include a feed system that advances the material being skived through the cutting mechanism and, in some instances, may be ejected, aggregated, and/or collected behind the cutting apparatus.

The disclosed automated skiving machines are configured to provide a number of advantages. For example, an operator using a cutting apparatus may experience fatigue which may cause a loss in quality and consistency. The disclosed automated skiving machines replace the operator with an automated procedure that advantageously maneuvers the cutting apparatus in a consistent and repeatable manner. To replace the two-handed operation of the cutting apparatus (e.g., to move the apparatus and to apply a targeted force), the disclosed automated skiving machines utilize a tailored weight via a weight cup weldment that applies a targeted downward force on the cutting apparatus of the skiving machine. The weight cup weldment provides a cantilevered weight fixture configured to apply a targeted force on the cutting apparatus while also allowing the cutting apparatus to react to the surface of the tissue. Furthermore, the mechanism for securing the cutting apparatus allows the cutting apparatus to roll and to pitch during movement to respond to variations in the surface of the tissue. Thus, the mechanism allows the cutting apparatus to float across the tissue while exerting a consistent downward force while also being able to rotate or move in different directions to follow the contour of the tissue. The result is that the disclosed automated skiving machines are able to skive a consistent tissue thickness across left-to-right and front-to-back of skived tissue (or tissue cut from a sample) with high quality.

### Example Automated Skiving Machines

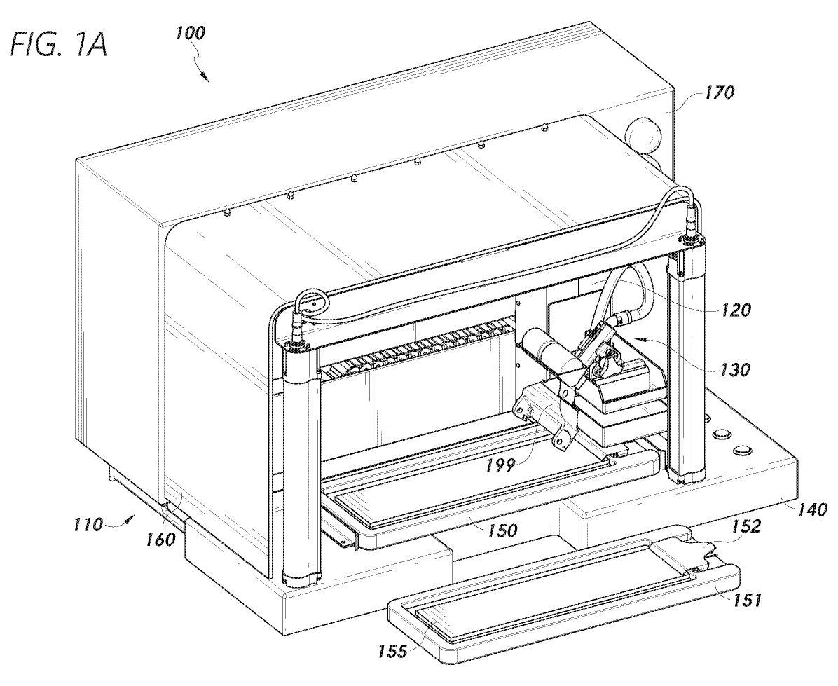

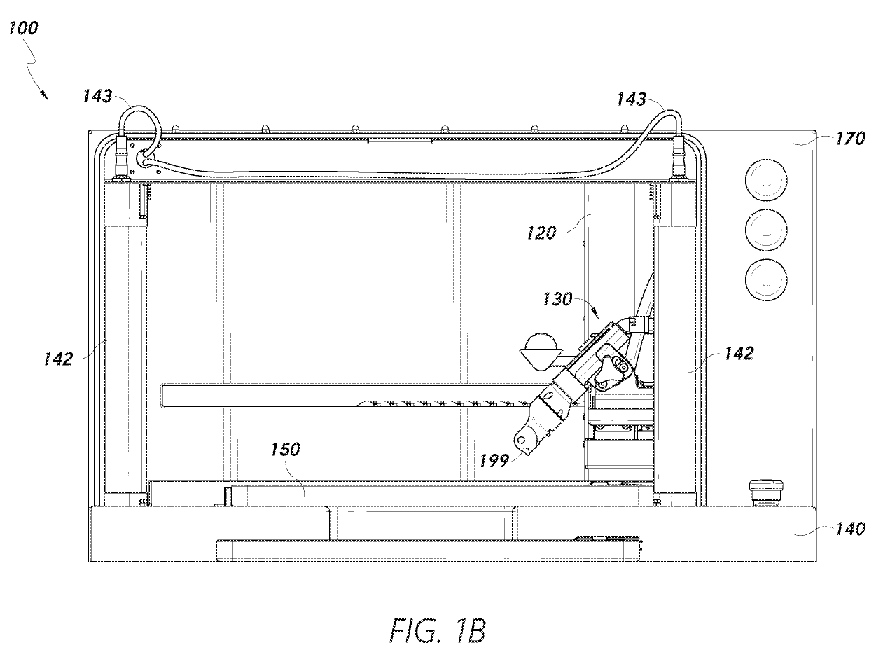

FIGS. 1A and 1B illustrate an example automated skiving machine 100. The automated skiving machine 100 includes a base assembly 110 comprising a tray platform assembly 140 coupled to a controls enclosure 170. The automated skiving machine 100 also includes a cutting assembly 130 that is coupled to a vertical actuator assembly 120 that together operate to hold a motor-driven dermatome 199 (or any other suitable cutting apparatus) and to move the motor-driven dermatome 199 across tissue secured by a tray drawer assembly 150 that sits on the tray platform assembly 140. The automated skiving machine 100 also includes a safety guard assembly 160 coupled to the tray platform assembly 140 to protect an operator of the automated skiving machine 100.

The base assembly 110 includes the controls enclosure 170 and the tray platform assembly 140 that are coupled to each other. The tray platform assembly 140 provides a platform for the tray drawer assembly 150 and includes user interface features (e.g., LEDs, buttons, switches, displays, etc.). The controls enclosure 170 houses controls, cables, actuators, and the like to control the cutting assembly 130.

In some implementations, the motor-driven dermatome 199 can be powered by pneumatics. In such implementations, pneumatic tubes 142 can be used to power the motor-driven dermatome 199, pneumatic hoses 143 coupling the pneumatic tubes 142 to the motor-driven dermatome 199 through the controls enclosure 170. The pneumatic tubes 142 can be secured or coupled to the tray platform assembly 140. In some implementations, the motor-driven dermatome 199 can be power by electricity. In such implementations, the pneumatic tubes 142 can be removed or replaced with batteries or other suitable electrical components and the pneumatic hoses 143 can be removed or replaced with electrical wiring for providing or controlling electrical power to the motor-driven dermatome 199.

In some implementations, the automated skiving machine 100 can be configured to detect the presence of the tray drawer assembly 150 in a targeted position on the tray platform assembly 140. If the tray drawer assembly 150 is not in the correct position or not present, the automated skiving machine 100 can be configured to not activate the cutting assembly 130 and/or move the cutting assembly 130. An additional tray drawer assembly 151 can also be used to prepare additional tissue for skiving. The tray drawer assembly 150 and the additional tray drawer assembly 151 each include a tissue clamp 152 for securing tissue on a tissue bed 155. The tissue bed 155 can be made from a compliant material, such as silicone or rubber.

The safety guard assembly 160 and the controls enclosure 170 are configured to protect the operator and/or electronics. For example, the safety guard assembly 160 and the controls enclosure 170 can be configured to keep exhaust fumes away from the operator. As another example, the safety guard assembly 160 and the controls enclosure 170 are configured to prevent or inhibit liquid from entering the housing or contacting the electronics. In addition, the safety guard assembly 160 and the controls enclosure 170 make the automated skiving machine 100 easy to clean.

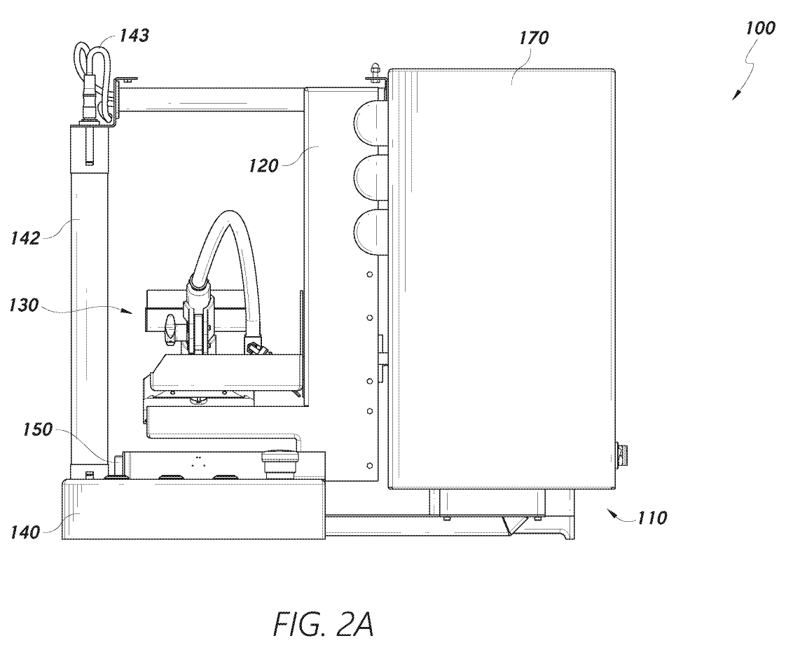

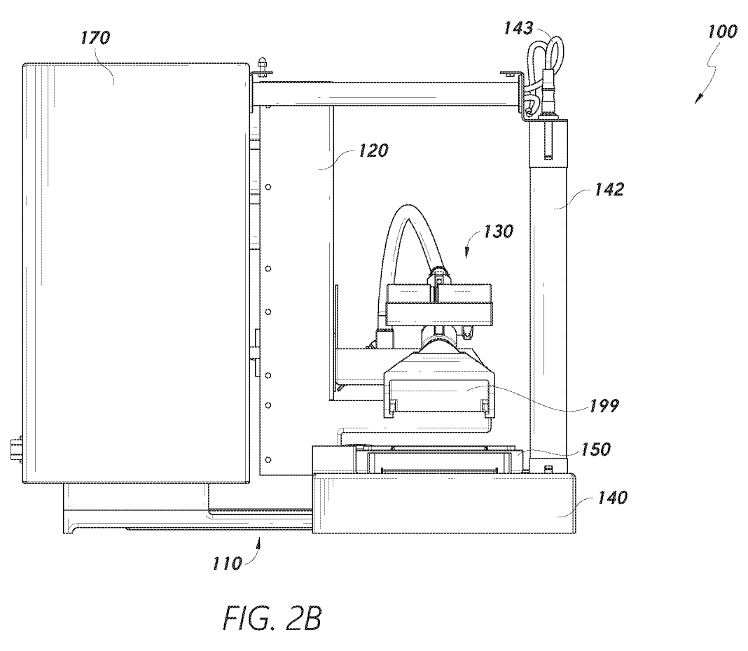

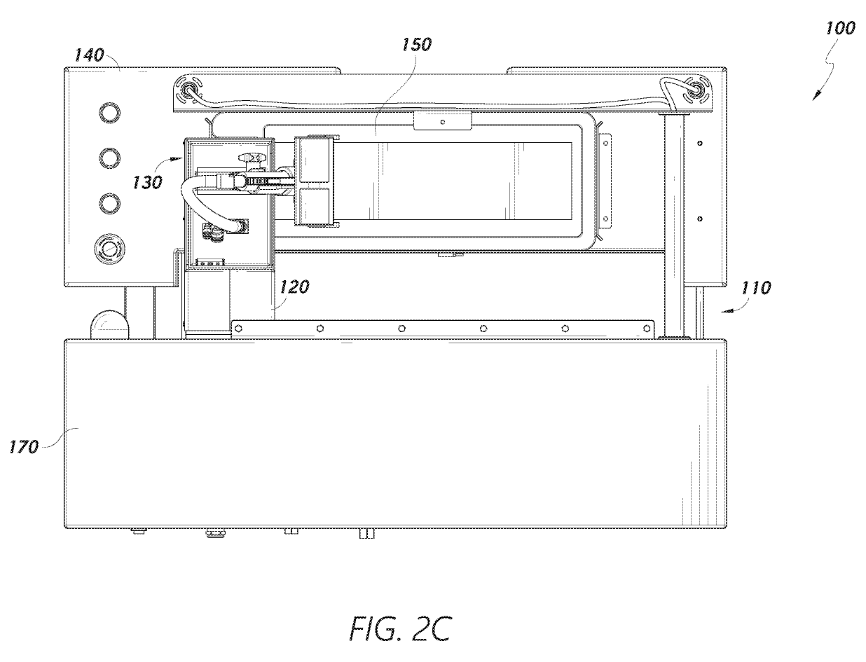

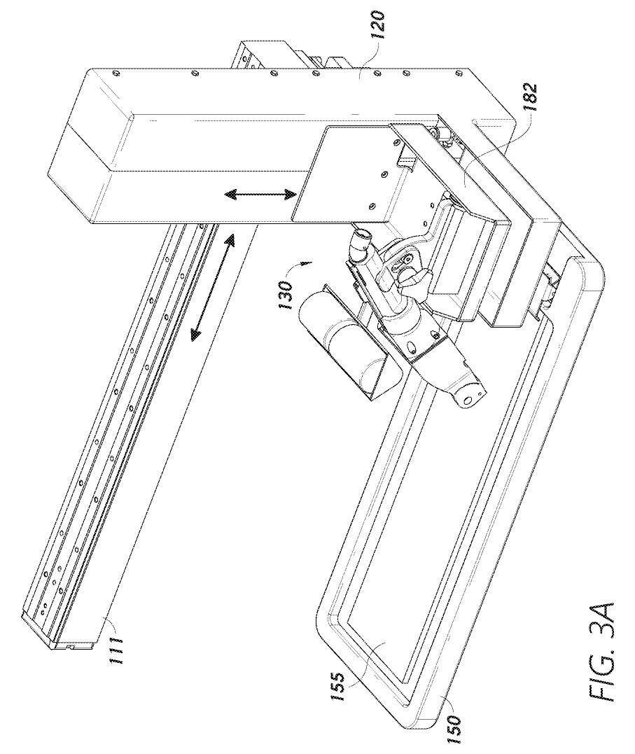

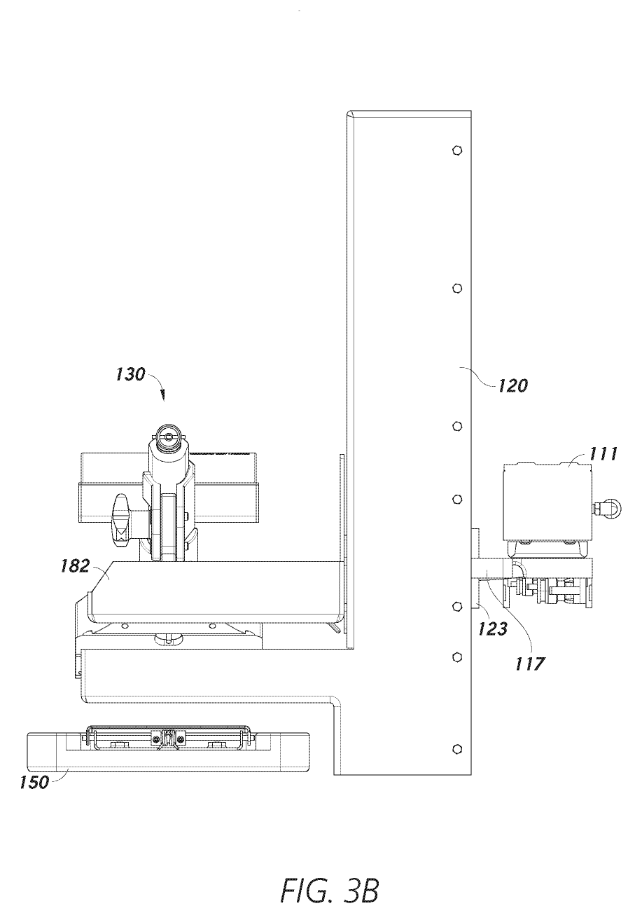

FIGS. 2A, 2B, and 2C illustrate additional views of the automated skiving machine 100 of FIGS. 1A and 1B with the safety guard assembly 160 removed. These views better illustrate that the vertical actuator assembly 120 interfaces with the controls enclosure 170 to enable movement of the cutting assembly 130. For example, the vertical actuator assembly 120 is configured to control vertical movement of the cutting assembly 130 (and hence the motor-driven dermatome 199) while the vertical actuator assembly 120 is configured to move horizontally relative to the tray platform assembly 140. Horizontal movement of the vertical actuator assembly 120 is accomplished through an interface between the vertical actuator assembly 120 and a horizontal actuator assembly housed within the controls enclosure 170, the horizontal actuator assembly described in greater detail herein with reference to FIGS. 3A and 3B. In some implementations, the automated skiving machine 100 can be manufactured or used without the safety guard assembly 160.

### Example Actuation of Automated Skiving Machines

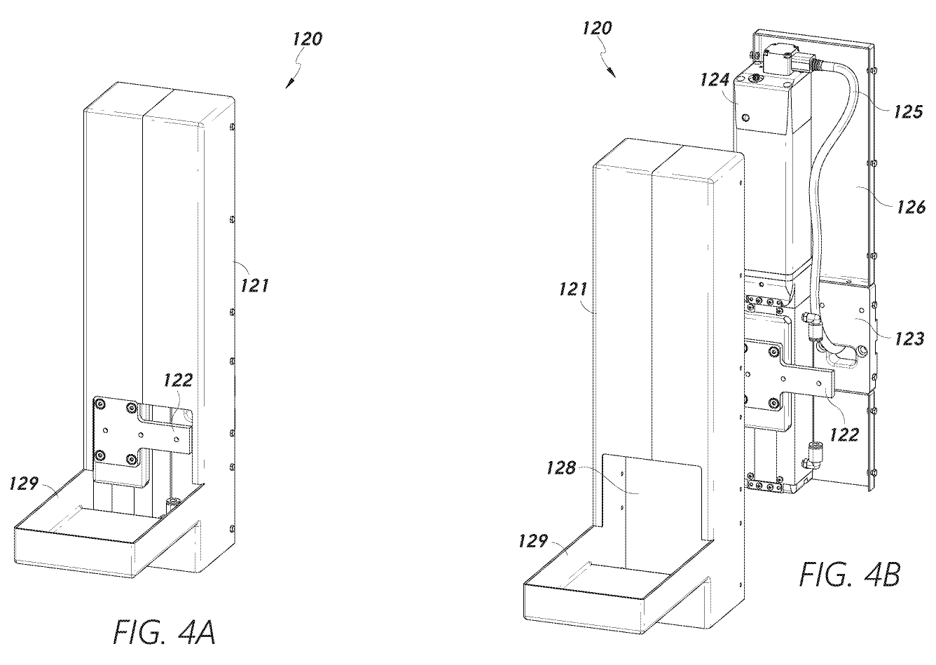

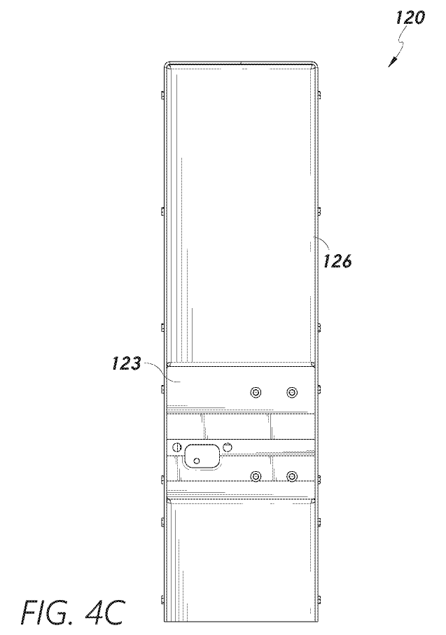

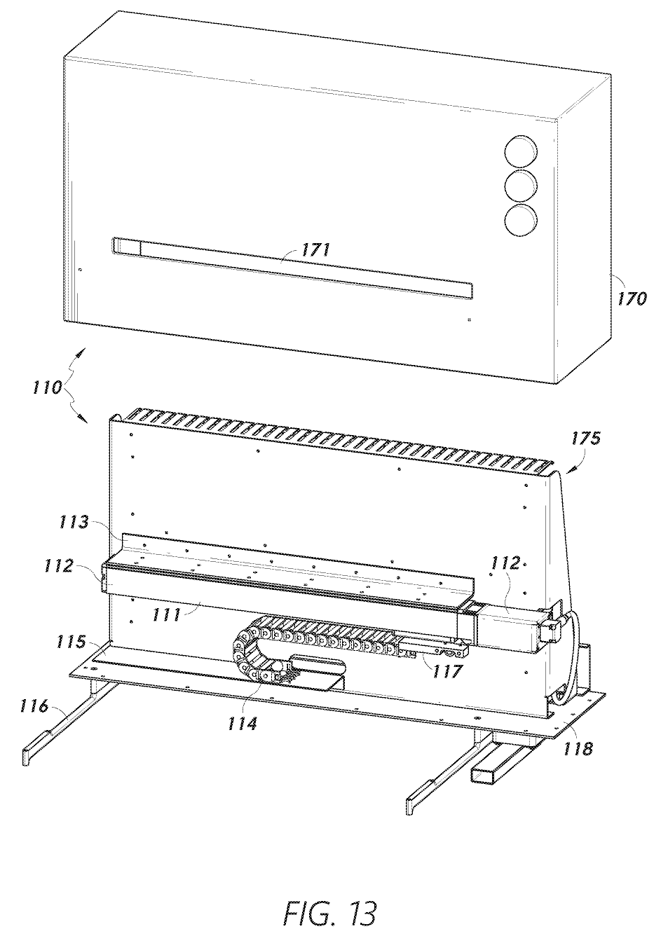

FIGS. 3A and 3B illustrate the vertical actuator assembly 120, the cutting assembly 130, a horizontal actuator assembly 111, and the tray drawer assembly 150 of the automated skiving machine 100 of FIGS. 1A and 1B. The horizontal actuator assembly 111 is housed within the controls enclosure 170 and enables horizontal movement of the vertical actuator assembly 120. As described in greater detail herein, the horizontal actuator assembly 111 moves a horizontal carriage 117 that couples to the vertical actuator assembly 120 via a vertical adapter 123 to enable horizontal movement of the vertical actuator assembly 120. The controls enclosure 170 forms an enclosure window 171 (see FIG. 13 and FIG. 1B) through which the vertical actuator assembly 120 is coupled to the horizontal carriage 117 via the vertical adapter 123. The vertical actuator assembly 120 enables vertical movement of the cutting assembly 130 by coupling a cantilever tray 182 of the cutting assembly 130 to the vertical actuator assembly 120 (via a cantilever adapter 122 described with reference to FIGS. 4A-4C). Thus, the vertical actuator assembly 120 can lower the cutting assembly 130 so that the motor-driven dermatome 199 contacts tissue secured on the tissue bed 155 of the tray drawer assembly 150 and the horizontal actuator assembly 111 can move the cutting assembly 130 horizontally (by moving the vertical actuator assembly 120 horizontally) while the vertical actuator assembly 120 is in a lowered position to skive the tissue on the tissue bed 155. After skiving the tissue on the tissue bed 155, the vertical actuator assembly 120 can move the cutting assembly 130 to a raised position. In the raised position, the horizontal actuator assembly 111 can move the cutting assembly 130 back to a start or ready position.

FIGS. 4A, 4B, and 4C illustrate the vertical actuator assembly 120. The vertical actuator assembly 120 includes a vertical actuator cover 121 and a vertical actuator rear cover 126 that together enclose a cantilever adapter 122, the vertical adapter 123, a vertical actuator 124, and a vertical actuator cable 125. The vertical actuator cover 121 forms a vertical actuator shelf 129 and a vertical actuator window 128 through which the cantilever adapter 122 couples with the cantilever tray 182 of the cutting assembly 130.

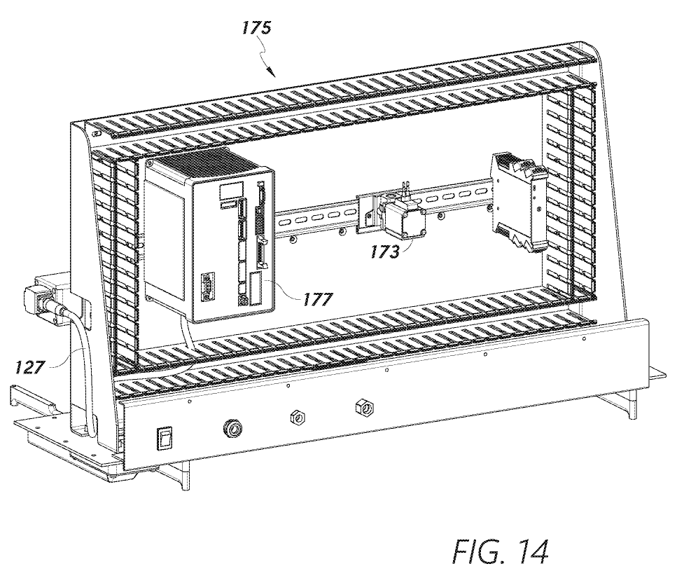

The vertical actuator 124 enables vertical movement of the cantilever adapter 122. This allows the cutting assembly 130 to be raised and lowered so that the motor-driven dermatome 199 can contact tissue for skiving the tissue or be raised above the tissue to reset the position of the cutting assembly 130 and/or to enable retrieval of skived tissue or replace the tray drawer assembly 150 (e.g., with the additional tray drawer assembly 151). In some implementations, the vertical movement of the cantilever adapter 122 is limited to be similar in range to the size of the vertical actuator window 128. In some implementations, the vertical actuator shelf 129 provides a lower bound for vertical movement of the cutting assembly 130 (e.g., the cantilever tray 182 will contact the vertical actuator shelf 129 to provide the lower bound). The vertical actuator 124 is coupled to an actuator motor controller 177 within the controls enclosure 170 (see FIG. 14) via the vertical actuator cable 125.

The vertical actuator rear cover 126 supports the vertical adapter 123, the vertical adapter 123 configured to be coupled to the horizontal carriage 117 of the horizontal actuator assembly 111 (see FIGS. 3A and 3B). Coupling of the vertical adapter 123 to the horizontal carriage 117 couples movement of the horizontal carriage 117 to the vertical actuator assembly 120 to enable horizontal movement of the vertical actuator assembly 120 which results in the horizontal movement of the cutting assembly 130 by way of the coupling of the cantilever adapter 122 and the cantilever tray 182.

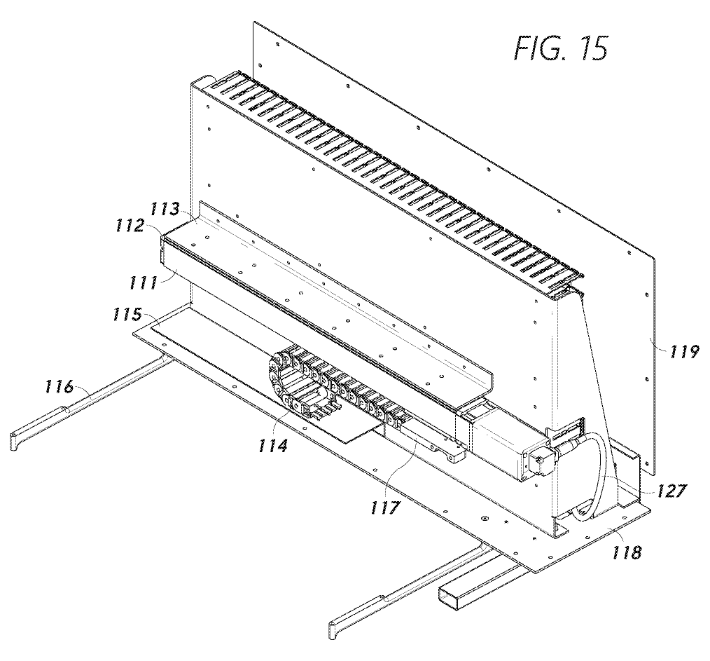

In some implementations, the horizontal actuator assembly 111 (and the horizontal actuator 112 of the horizontal actuator assembly 111, shown in FIGS. 13 and 15) and the vertical actuator 124 can be programmed to a particular length of cut of tissue. Once the motor-driven dermatome 199 reaches the pre-programmed length, the vertical actuator assembly 120 lifts the motor-driven dermatome 199 and returns back to its original position to the right of the tray drawer assembly 150 (from the point of view of an operator in front of the automated skiving machine 100).

In some implementations, an automated skiving procedure can be programmed into the automated skiving machine 100. As part of the automated skiving procedure, a button can be pressed (or other user interface feature can be operated) to cause the motor-driven dermatome 199 to move down (if a sensor determines that the tray drawer assembly 150 is in place). Once the tissue is verified to be fastened correctly in the tray drawer assembly 150, the button can be pressed again to do a skiving pass, after which the motor-driven dermatome 199 is lifted to allow retrieval of the skived tissue. The button can be pressed once more to cause the motor-driven dermatome 199 to return back to its home position.

The speed of the motor-driven dermatome 199 across the tissue can be tailored or programmed. The speed can be related to the downward force applied by the motor-driven dermatome 199 (e.g., through the weights 139 in the weight cup 136, as described herein). In some implementations, and by way of example, a targeted speed of the motor-driven dermatome 199 can be between about 8 inches per minute and about 14 inches per minute. Other speeds can be used and can vary from the stated range of 8-14 inches per minute, the speed based at least in part on the specific application, the properties of the motor-driven dermatome 199, the properties of the tissue being skived, and so on.

### Example Cutting Assemblies of Automated Skiving Machines

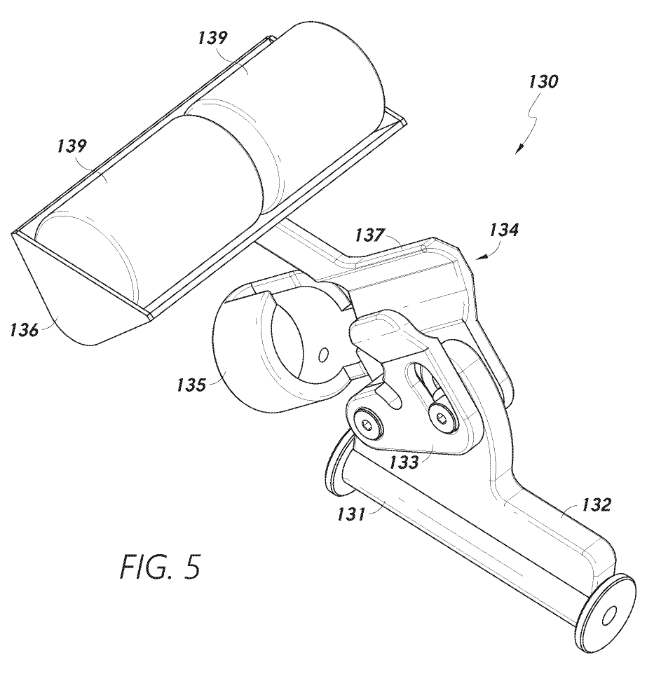

FIG. 5 illustrates a portion of the cutting assembly 130 without the motor-driven dermatome 199. The cutting assembly 130 includes a pivot pin 131 coupled to a clamp base 132 that in turn couples to a skiver clamp 133 and a weight cup weldment 134. The weight cup weldment 134 includes a weight cup 136 attached to a weight tray arm 137. The cutting assembly 130 also includes a stop ring 135 to hold a cutting apparatus in place in the cutting assembly 130. Weights 139 can be placed in the weight cup 136 to achieve a targeted downward force on a cutting apparatus held by the cutting assembly 130. The skiver clamp 133 and the weight tray arm 137 combine to secure the cutting apparatus. The weight tray arm 137 transfers the force from the weight cup 136 to the cutting apparatus via the clamping force of the skiver clamp 133 and the weight tray arm 137 on the cutting apparatus.

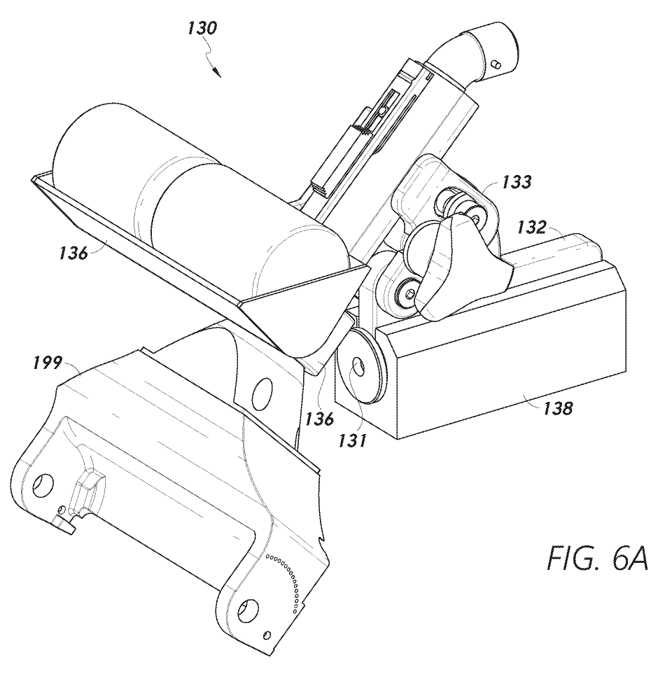

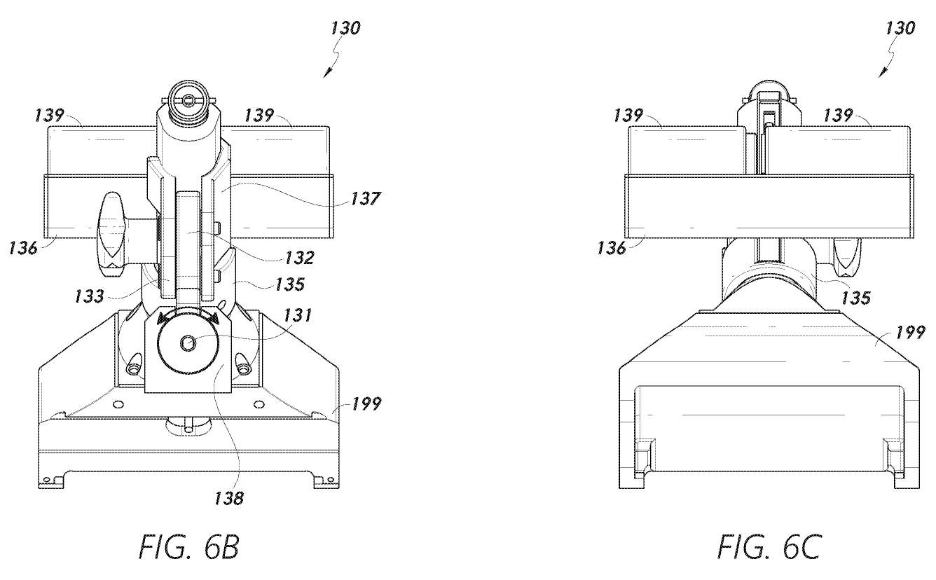

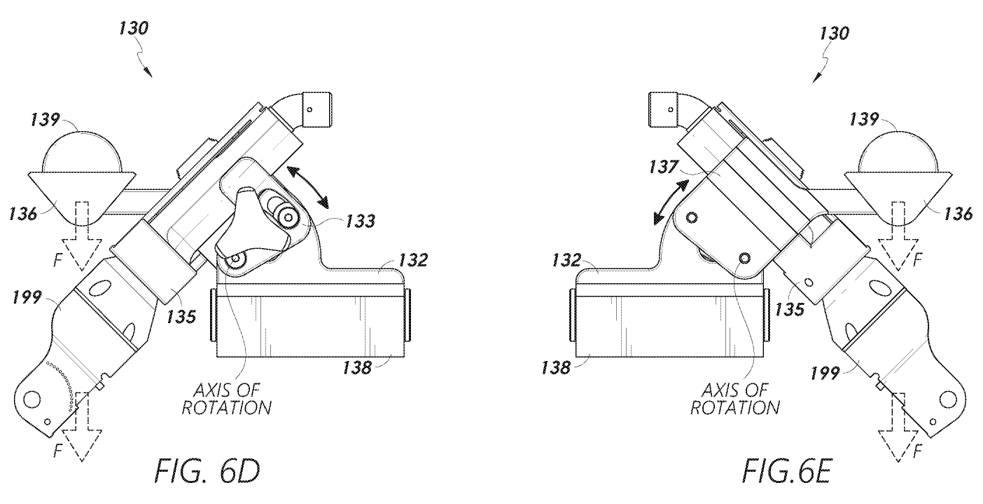

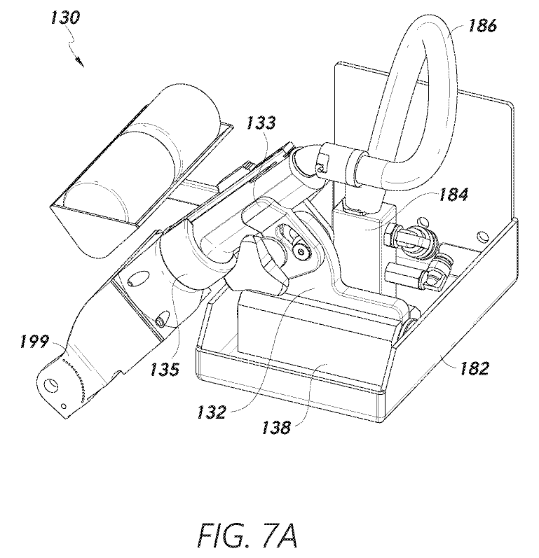

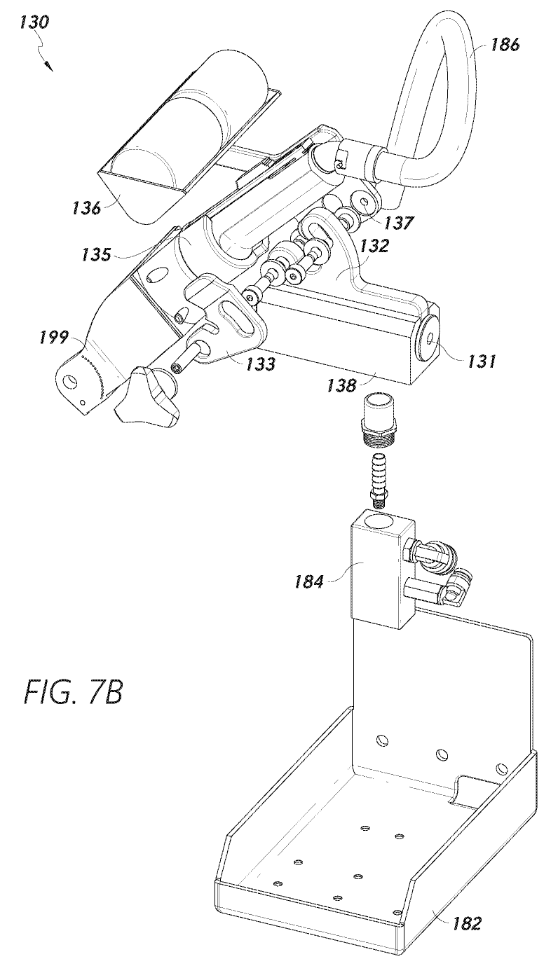

FIGS. 6A, 6B, 6C, 6D, 6E illustrate various views of the cutting assembly 130. The motor-driven dermatome 199 is secured in the cutting assembly 130 by pressing the skiver clamp 133 and the weight tray arm 137 towards one another (using any suitable mechanism, such as a screw attached to a rotating knob as illustrated). The pivot pin 131 is positioned within a pillow block 138 and the pillow block 138 is in turn secured to the cantilever tray 182 (as shown in FIGS. 7A and 7B).

The cutting assembly 130 enables targeted movement of the motor-driven dermatome 199. The targeted movement allows the motor-driven dermatome 199 to float over the surface of tissue being skived. In other words, the motor-driven dermatome 199 is able to respond to variations in the surface of the tissue being skived. The cutting assembly 130 enables the motor-driven dermatome 199 to roll (e.g., rotation around the front-to-back axis) and to pitch (e.g., rotation around the side-to-side axis). As illustrated in FIG. 6B, the pivot pin 131 comprises a pin that is positioned within a complementary cylindrical opening formed by the pillow block 138. This allows the pivot pin 131 to rotate, in a limited fashion, along a front-to-back axis within the pillow block 138 (as indicated by the curved line with arrows in FIG. 6B). This limited rotation allows the motor-driven dermatome 199 to roll while being secured by the cutting assembly 130.

As illustrated in FIGS. 6D and 6E, the skiver clamp 133 is secured to the weight tray arm 137 using a pair of pins (that run through the clamp base 132). The lower pin from the weight tray arm 137 couples to a circular opening of the skiver clamp 133 to establish an axis of rotation. The upper pin from the weight tray arm 137 is positioned within a curved slot of the skiver clamp 133. This curved slot enables the skiver clamp 133 and the weight tray arm 137 to rotate, in a limited fashion, relative to the clamp base 132 along a side-to-side axis (as indicated by the curved lines with arrows in FIGS. 6D and 6E). This limited rotation allows the motor-driven dermatome 199 to pitch while being secured by the cutting assembly 130. Advantageously, limiting the amount of pitch and/or roll inhibits or prevents the motor-driven dermatome 199 from digging an edge into the tissue during the skiving process.

As illustrated in FIGS. 6D and 6E, weights 139 can be placed in the weight cup 136 to achieve a tailored or targeted downward force (and torque) on the motor-driven dermatome 199. In some implementations, the amount of weight in the weight cup 136 can be tailored based on one or more studies to determine a suitable weight to achieve targeted results, such as a targeted thickness of skived tissue. In some implementations, the amount of weight determines the thickness of the skived tissue rather than a thickness setting on the motor-driven dermatome 199. Once a targeted weight is determined that same weight can be used to achieve consistent results. The position of the weight cup 136 relative to the motor-driven dermatome 199 and/or the axis of rotation can be tailored to achieve targeted results.

As illustrated in FIG. 6D, an approach angle, A, of the motor-driven dermatome 199 relative to horizontal can be tailored by using a clamp base 132, skiver clamp 133, and weight cup weldment 134 with tailored properties to achieve the angle, A. In some implementations, an approach angle, A, can be configured to be between about 29 degrees and about 40 degrees. The amount of weight in the weight cup 136 can also be tailored based on the approach angle, A. Thus, as described herein, three elements of the automated skiving machine 100 can be tuned or tailored to achieve desirable results (e.g., skived tissue with a targeted thickness and free from defects). The three elements include the approach angle, A, the weight in the weight cup 136, and the horizontal speed of the motor-driven dermatome 199 over the tissue.

FIGS. 7A and 7B illustrate an assembled view and an exploded view of the cutting assembly 130 with additional components for the motor-driven dermatome 199. The cutting assembly 130 includes the cantilever tray 182, as described herein. The pillow block 138 is mounted to the cantilever tray 182. The cantilever tray 182 is also attached to the cantilever adapter 122 of the vertical actuator assembly 120, as described herein.

In some implementations, the motor-driven dermatome 199 can be powered using pneumatics. In such implementations, the cutting assembly 130 also includes a hose manifold 184 mounted to the cantilever tray 182. The hose manifold 184 is configured to deliver pneumatic pressure to the motor-driven dermatome 199 to operate the motor-driven dermatome 199 via the dermatome hose 186. For an electric dermatome, for example, the hose manifold 184 could be replaced by an electronic connector that helps to deliver electrical power to the electric dermatome through electrical wiring that replaces the dermatome hose 186.

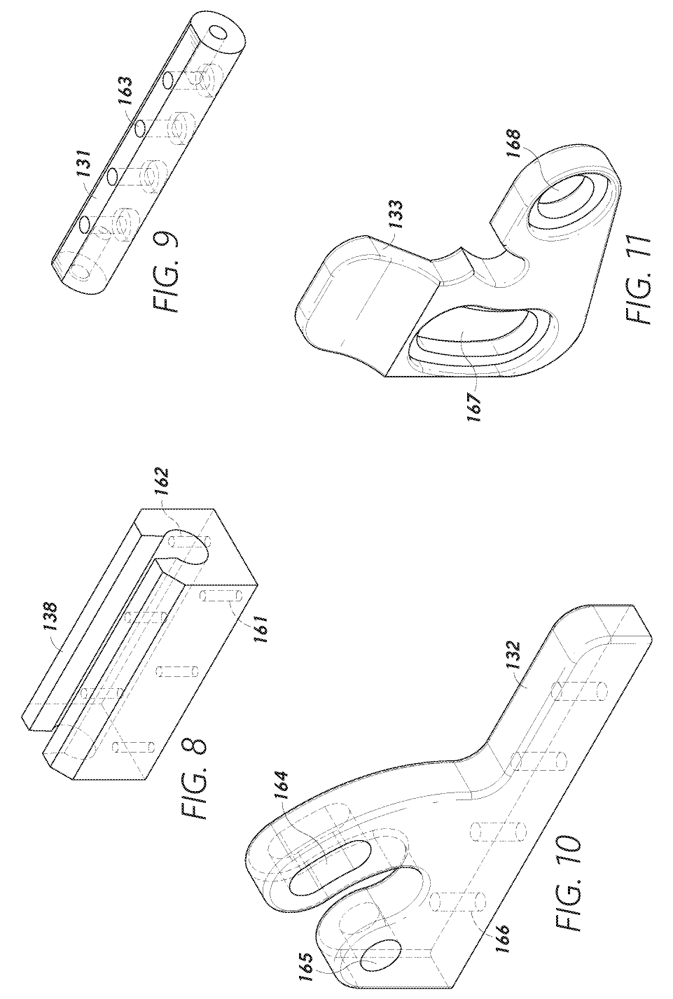

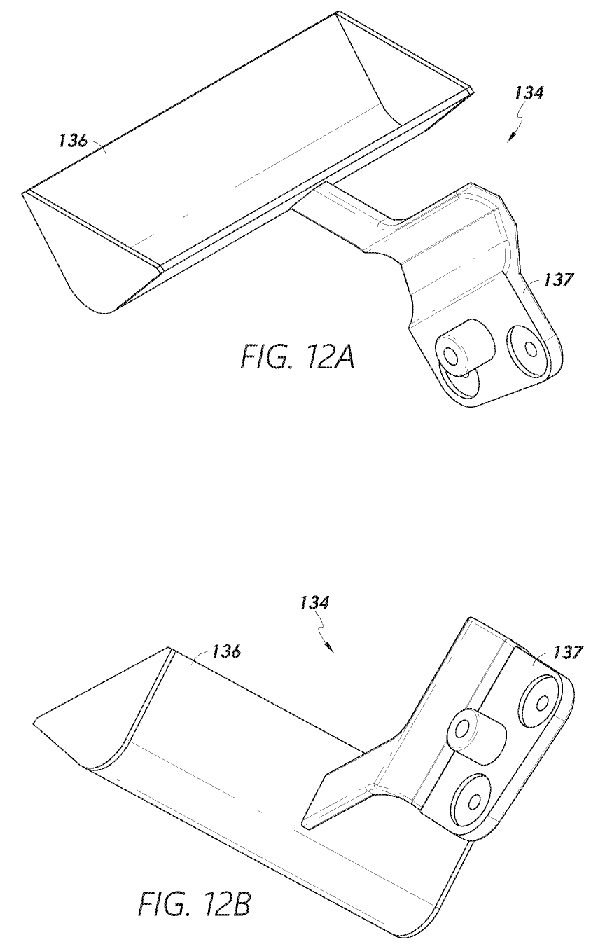

The exploded view in FIG. 7B illustrates the various pins, washers, and other components that couple the skiver clamp 133, clamp base 132, and weight tray arm 137 to each other to enable the motor-driven dermatome 199 to move as described herein with reference to FIGS. 6D and 6E. In addition, FIG. 8 illustrates the pillow block 138, FIG. 9 illustrates the pivot pin 131, FIG. 10 illustrates the clamp base 132, FIG. 11 illustrates the skiver clamp 133, and FIGS. 12A and 12B illustrate the weight cup weldment 134.

With reference to FIG. 8, the pillow block 138 forms a cylindrical opening 162 into which the pivot pin 131 fits. The pillow block 138 also includes mounting holes 161 to enable the pillow block 138 to be mounted to the cantilever tray 182. With reference to FIG. 9, the pivot pin 131 includes mounting holes 163 to couple the pivot pin 131 to the clamp base 132, which has complementary mounting holes 166 (as illustrated in FIG. 10). With reference to FIGS. 10-12B, the clamp base 132 also includes a circular opening 165 through which a pin extends from the weight tray arm 137 to a corresponding circular opening 168 of the skiver clamp 133. As described herein, this establishes an axis of rotation for the motor-driven dermatome 199 to allow the motor-driven dermatome 199 to pitch. The clamp base 132 also includes a slot 164 through which a pin extends from the weight tray arm 137 to a corresponding slot 167 of the skiver clamp 133. As described herein, this allows the skiver clamp 133 and the weight tray arm 137 to rotate around the established axis of rotation to allow the motor-driven dermatome 199 to pitch.

### Example Controls and Assemblies of Automated Skiving Machines

FIG. 13 illustrates the base assembly 110. The base assembly 110 includes the horizontal actuator assembly 111 to provide horizontal movement to the cutting assembly 130, as described herein. The horizontal actuator assembly 111 includes horizontal actuators 112 that move the horizontal carriage 117 along the horizontal actuator assembly 111. Coupled to the horizontal carriage 117 is a cable carrier 114 to couple cables to the cutting assembly 130 during movement of the cutting assembly 130. The base assembly 110 also includes an actuator shelf 113 and a cable carrier shelf 115 to respectively secure the horizontal actuator assembly 111 and the cable carrier 114 to the base assembly 110. The base assembly 110 includes mounting rails 116 to couple the base assembly 110 to the tray platform assembly 140. The base assembly 110 also includes a base plate 118 to hold a controls assembly 175 within the controls enclosure 170. As described herein, the controls enclosure 170 forms an enclosure window 171 through which the horizontal carriage 117 couples to the vertical adapter 123 of the vertical actuator assembly 120.

FIGS. 14 and 15 illustrate various views of the controls assembly 175. The controls assembly 175 includes an actuator motor controller 177 that controls the actuators of the horizontal actuator assembly 111 and the vertical actuator assembly 120. The controls assembly 175 is coupled to the horizontal actuators 112 through a horizontal actuator cable 127 that connects the horizontal actuators 112 to the actuator motor controller 177. The controls assembly 175 also includes a rear base enclosure 119.

In some implementations, the motor-driven dermatome 199 is a pneumatic dermatome. In such implementations, the controls assembly 175 includes a pneumatic valve 173 that provides pneumatic pressure to the motor-driven dermatome 199 through the hose manifold 184 and dermatome hose 186 described herein with reference to FIGS. 7A and 7B. In certain implementations, the motor-driven dermatome 199 is an electric dermatome. In such implementations, the controls assembly 175 includes a switch, relay, or other electrical component to replace the pneumatic valve 173 to control the flow of electrical power to the motor-driven dermatome 199 through an electronic connector and electrical wiring, as described herein.

### Example Implementations

The following is an enumerated list of example implementations. This list is intended to illustrate various combinations of features and is not intended to limit the possible combinations of features to those explicitly identified in the enumerated list. Accordingly, the scope of disclosed subject matter extends beyond what is included in the following list.

Example 1: An automated skiving machine comprising: a cutting assembly configured to secure a cutting apparatus, the cutting assembly configured to enable the cutting apparatus to pitch and roll as the cutting apparatus skives a tissue, the cutting assembly configured to apply a tailored downward force on the cutting apparatus; a vertical actuator assembly coupled to the cutting assembly and configured to vertically move the cutting assembly; and a horizontal actuator assembly coupled to the vertical actuator assembly and configured to horizontally move the vertical actuator assembly.

Example 2: The automated skiving machine of example 1 further comprising a tray drawer assembly configured to hold the tissue to be skived.

Example 3: The automated skiving machine of example 2, wherein the tray drawer assembly includes a tissue clamp and a tissue bed.

Example 4: The automated skiving machine of any of examples 2-3 further comprising a tray platform assembly to support the tray drawer assembly.

Example 5: The automated skiving machine of any of examples 1-4, wherein the cutting assembly comprises a pillow block and a pivot pin positioned within the pillow block, the pivot pin configured to rotate within the pillow block to allow the cutting assembly to roll as the cutting apparatus skives the tissue.

Example 6: The automated skiving machine of any of examples 1-5, wherein the cutting assembly comprises a clamping system that includes a skiver clamp and a weight cup weldment, the clamping system including a first pin coupled to the weight cup weldment that is secured within a circular opening of the skiver clamp to establish an axis of rotation and a second pin coupled to the weight cup weldment that is secured within a slot of the skiver clamp to allow the cutting assembly to pitch as the cutting apparatus skives the tissue.

Example 7: The automated skiving machine of any of examples 1-6, wherein the cutting assembly further includes a weight cup coupled to a clamping system of the cutting assembly, the weight cup configured to hold one or more weights to achieve the tailored downward force on the cutting apparatus.

Example 8: The automated skiving machine of any of examples 1-7, wherein the vertical actuator assembly includes a cantilever adapter coupled to a cantilever tray of the cutting assembly, the vertical actuator assembly further including a vertical actuator that vertically moves the cantilever adapter to thereby vertically move the cutting assembly.

Example 9: The automated skiving machine of example 8, wherein the vertical actuator assembly further includes a vertical actuator shelf that defines a lower bound for vertical movement of the cutting assembly, the cantilever tray of the cutting assembly configured to contact the vertical actuator shelf at the lower bound of vertical movement.

Example 10: The automated skiving machine of any of examples 8-9, wherein the horizontal actuator assembly includes a horizontal carriage that couples to a vertical adapter of the vertical actuator assembly, the horizontal actuator assembly further including a horizontal actuator that horizontally moves the horizontal carriage to thereby horizontally move the vertical actuator assembly and the cutting assembly.

Example 11: A method for automated tissue skiving, the method comprising: securing a cutting apparatus in a cutting assembly that is configured to enable the cutting apparatus to pitch and roll as the cutting apparatus skives a tissue; applying a tailored downward force on the cutting apparatus; vertically moving the cutting assembly to engage with tissue using a vertical actuator assembly coupled to the cutting assembly; and horizontally moving the vertical actuator assembly that is coupled to the cutting assembly, wherein horizontally moving the vertical actuator assembly causes the cutting assembly to horizontally move over the tissue to skive the tissue, the cutting assembly allowing the cutting apparatus to pitch and roll as the cutting assembly skives the tissue.

Example 12: The method of example 11 further comprising securing a tissue in a tray drawer assembly beneath the cutting assembly.

Example 13: The method of example 12, wherein the tray drawer assembly includes a tissue clamp and a tissue bed.

Example 14: The method of any of examples 11-13 further comprising operating a user interface feature to initiate tissue skiving.

Example 15: The method of example 14 further comprising, responsive to detecting that a tray drawer assembly is not in position, turning off the cutting apparatus.

Example 16: The method of any of examples 11-15, wherein the cutting assembly comprises a clamping system that includes a skiver clamp and a weight cup weldment, the clamping system including a first pin coupled to the weight cup weldment that is secured within a circular opening of the skiver clamp to establish an axis of rotation and a second pin coupled to the weight cup weldment that is secured within a slot of the skiver clamp to allow the cutting assembly to pitch as the cutting apparatus skives the tissue.

Example 17: The method of any of examples 11-16, wherein applying the tailored downward force on the cutting apparatus includes holding weights in a weight cup of the cutting assembly that is coupled to a clamping system of the cutting assembly.

Example 18: The method of any of examples 11-17, wherein vertically moving the cutting assembly includes operating a vertical actuator that vertically moves a cantilever adapter coupled to a cantilever tray of the cutting assembly.

Example 19: The method of example 18 further comprising limiting vertical movement of the vertical actuator assembly using a vertical actuator shelf that defines a lower bound for vertical movement of the cutting assembly, the cantilever tray of the cutting assembly configured to contact the vertical actuator shelf at the lower bound of vertical movement.

Example 20: The method of any of examples 18-19, wherein horizontally moving the vertical actuator assembly includes operating a horizontal actuator to horizontally move a horizontal carriage that couples to a vertical adapter of the vertical actuator assembly to thereby horizontally move the cutting assembly.

### Additional Embodiments and Terminology

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general-purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general-purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems and are not limited to the methods and systems described above, and elements and acts of the various embodiments described above can be combined to provide further embodiments. Accordingly, the novel methods and systems described herein may be embodied in a variety of other forms; furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. An automated skiving machine comprising:
a cutting assembly configured to secure a cutting apparatus, the cutting assembly configured to enable the cutting apparatus to pitch and roll as the cutting apparatus skives a tissue, the cutting assembly configured to apply a tailored downward force on the cutting apparatus;
a vertical actuator assembly coupled to the cutting assembly and configured to vertically move the cutting assembly; and
a horizontal actuator assembly coupled to the vertical actuator assembly and configured to horizontally move the vertical actuator assembly.

2. The automated skiving machine of claim 1 further comprising a tray drawer assembly configured to hold the tissue to be skived.

3. The automated skiving machine of claim 2, wherein the tray drawer assembly includes a tissue clamp and a tissue bed.

4. The automated skiving machine of claim 2 further comprising a tray platform assembly to support the tray drawer assembly.

5. The automated skiving machine of claim 1, wherein the cutting assembly comprises a pillow block and a pivot pin positioned within the pillow block, the pivot pin configured to rotate within the pillow block to allow the cutting assembly to roll as the cutting apparatus skives the tissue.

6. The automated skiving machine claim 1, wherein the cutting assembly comprises a clamping system that includes a skiver clamp and a weight cup weldment, the clamping system including a first pin coupled to the weight cup weldment that is secured within a circular opening of the skiver clamp to establish an axis of rotation and a second pin coupled to the weight cup weldment that is secured within a slot of the skiver clamp to allow the cutting assembly to pitch as the cutting apparatus skives the tissue.

7. The automated skiving machine of claim 1, wherein the cutting assembly further includes a weight cup coupled to a clamping system of the cutting assembly, the weight cup configured to hold one or more weights to achieve the tailored downward force on the cutting apparatus.

8. The automated skiving machine claim 1, wherein the vertical actuator assembly includes a cantilever adapter coupled to a cantilever tray of the cutting assembly, the vertical actuator assembly further including a vertical actuator that vertically moves the cantilever adapter to thereby vertically move the cutting assembly.

9. The automated skiving machine of claim 8, wherein the vertical actuator assembly further includes a vertical actuator shelf that defines a lower bound for vertical movement of the cutting assembly, the cantilever tray of the cutting assembly configured to contact the vertical actuator shelf at the lower bound of vertical movement.

10. The automated skiving machine of claim 8, wherein the horizontal actuator assembly includes a horizontal carriage that couples to a vertical adapter of the vertical actuator assembly, the horizontal actuator assembly further including a horizontal actuator that horizontally moves the horizontal carriage to thereby horizontally move the vertical actuator assembly and the cutting assembly.

11. A method for automated tissue skiving, the method comprising:
securing a cutting apparatus in a cutting assembly that is configured to enable the cutting apparatus to pitch and roll as the cutting apparatus skives a tissue;
applying a tailored downward force on the cutting apparatus;
vertically moving the cutting assembly to engage with tissue using a vertical actuator assembly coupled to the cutting assembly; and
horizontally moving the vertical actuator assembly that is coupled to the cutting assembly, wherein horizontally moving the vertical actuator assembly causes the cutting assembly to horizontally move over the tissue to skive the tissue, the cutting assembly allowing the cutting apparatus to pitch and roll as the cutting assembly skives the tissue.

12. The method of claim 11 further comprising securing a tissue in a tray drawer assembly beneath the cutting assembly.

13. The method of claim 12, wherein the tray drawer assembly includes a tissue clamp and a tissue bed.

14. The method of claim 11 further comprising operating a user interface feature to initiate tissue skiving.

15. The method of claim 14 further comprising, responsive to detecting that a tray drawer assembly is not in position, turning off the cutting apparatus.

16. The method of claim 11, wherein the cutting assembly comprises a clamping system that includes a skiver clamp and a weight cup weldment, the clamping system including a first pin coupled to the weight cup weldment that is secured within a circular opening of the skiver clamp to establish an axis of rotation and a second pin coupled to the weight cup weldment that is secured within a slot of the skiver clamp to allow the cutting assembly to pitch as the cutting apparatus skives the tissue.

17. The method of claim 11, wherein applying the tailored downward force on the cutting apparatus includes holding weights in a weight cup of the cutting assembly that is coupled to a clamping system of the cutting assembly.

18. The method of claim 11, wherein vertically moving the cutting assembly includes operating a vertical actuator that vertically moves a cantilever adapter coupled to a cantilever tray of the cutting assembly.

19. The method of claim 18 further comprising limiting vertical movement of the vertical actuator assembly using a vertical actuator shelf that defines a lower bound for vertical movement of the cutting assembly, the cantilever tray of the cutting assembly configured to contact the vertical actuator shelf at the lower bound of vertical movement.

20. The method of claim 18, wherein horizontally moving the vertical actuator assembly includes operating a horizontal actuator to horizontally move a horizontal carriage that couples to a vertical adapter of the vertical actuator assembly to thereby horizontally move the cutting assembly.
